(19) United States
(12) Patent Application Publication
(10) Pub. No.: US 2016/0176255 A1
(43) Pub. Date: Jun. 23, 2016

(54) Multi Purpose Passenger Vehicle

(71) Applicant: Thomas Guiboche, Winnipeg (CA)

(72) Inventor: Thomas Guiboche, Winnipeg (CA)

(21) Appl. No.: 14/575,253

(22) Filed: Dec. 18, 2014

(51) Int. Cl. B60F 3/00; B62D 57/00

(52) U.S. Cl. CPC B60F 3/0069; B62D 57/00; B60F 3/0007; B60F 3/0038

(57) ABSTRACT

A passenger vehicle which can be converted from snow to road to water use includes a generally rectangular frame with fabric panels on the frame defining a seat for the passenger. A generally horizontal front platform is connected to the front cross member and can tilt front to rear and side to side and a symmetrical rear platform is connected to the rear cross member. Front and rear ski assemblies are arranged for attachment to the front and rear platforms for movement therewith and for steering movement relative thereto operated by steering levers. The skis can have wheels attached for road use and the skis can be removed and replaced by annular float tubes for water use. Cross links communicated steering movement of the front support to the rear or the rear can be locked.

This invention relates to a multi-purpose passenger vehicle which can be used for example on snow, on flat ground and on water using the same base frame structure.

### BACKGROUND OF THE INVENTION

Many vehicles have been designed for single passenger travel as a sled to travel over snow and ice or as a cart to travel over the ground. Other water craft are available.

U.S. Pat. No. 5,344,167 (Strouth) issued Sep. 6, 1994 shows a conventional sled with two runners with a tubular frame supporting a seat mounted on the runners. However this provides no steering and no ability to convert to different modes of transport.

U.S. Pat. 6,736,414 (Farralay-Plourde) issued May 18, 2004 shows a snow scooter arrangement on which is placed a bicycle type seat and handle bars with front and rear skis allowing steering of the front ski by the handle bars. However this arrangement provides no ability to convert to different modes of transport.

### SUMMARY OF THE INVENTION

It is an object of the present invention to provide a passenger vehicle.

According to the invention there is provided an apparatus for transporting a passenger comprising:

a generally rectangular frame defining two side rails a front cross member and a rear cross member;

a seat on the frame for at least one passenger;

a generally horizontal front axle connected to the front cross member;

a generally horizontal rear axle connected to the rear cross member;

two transversely spaced front support members attached to the front axle for movement therewith and for supporting the front axle for movement across the a support surface;

two transversely spaced rear support members attached to the front axle for movement therewith and for supporting the front axle for movement across the support surface;

a swivel coupling for steering movement of the front support members relative to the frame about an upstanding steering axis;

a swivel coupling between the rear axle and frame for steering movement of the rear support members relative to the frame about an upstanding steering axis;

a pair of steering levers each on a respective side of the frame for operation by the passenger in forward and rearward movement of the steering lever, each lever having a steering link extending from the lever to the front axle for causing steering movement of the front axle relative to the frame;

and a first diagonally extending flexible connecting link extending from a right hand end of the front axle to a left hand end of the rear axle and a second diagonally extending flexible connecting link extending from a left hand end of the front axle to a right hand end of the rear axle so that operation of the levers causes the front support members to turn in one direction while the rear support members turn in the opposite direction.

Preferably the front axle includes a first single coupling allowing steering movement of the front axle relative to the frame in a wagon steering mode and includes two second couplings allowing individual steering movements of the support members relative to the front axle in a vehicle steering mode, wherein the rear axle includes a first single coupling allowing steering movement of the rear axle relative to the frame in a wagon steering mode and includes two second couplings allowing individual steering movements of the support members relative to the rear axle in a vehicle steering mode, and wherein there is provided an arrangement for selecting either the first single coupling or the two second couplings to change the steering modes.

Preferably each of the support members of the front axle is mounted on a support link which is connected to the front axle by one of the second couplings and wherein the steering link extends from the lever to the support link.

Preferably the selection of the wagon steering mode is obtained by inserting a locking pin at the support link and removing a locking pin at the axle and wherein the selection of the vehicle steering mode is obtained by removing a locking pin at the support link and inserting a locking pin at the axle.

Preferably the levers are mounted at respective sides of the frame and pivotal at the frame about an axis parallel to the axles.

Preferably rein the support members comprise skis.

Preferably each of the skis includes a longitudinally extending blade therein.

Preferably the support members are replaceable so that a selection can be made between wheels, skis and a float assembly.

Preferably each float assembly includes an annular float member arranged horizontally under the respective axle.

Preferably each of the float assemblies includes a guide fin longitudinally of the respective float assembly for guiding movement over water longitudinally.

Preferably each of the support members includes a pair of outwardly extending paddle members each arranged to paddle rearwardly on the surface when moved rearwardly such that side to side steering movements of the support members cause alternate paddling actions of the paddle members to propel the frame forwardly over the surface.

Preferably the paddle members are arranged to paddle against the surface in the rearward direction and to side over the surface a forward direction.

Preferably the frame includes a front platform providing a downwardly facing surface against which the front axle slides and a rear platform providing a downwardly facing surface against which the rear axle slides.

Preferably the seat assembly is formed by fabric panels.

In one mode of operation there is provided a swivel bearing between the rear platform and the horizontal rear support for steering movement of the rear support relative to the rear platform about an upstanding steering axis and the rear support can be locked against steering movement.

In another mode of operation there is provided a swivel bearing between the rear platform and the horizontal rear support for steering movement of the rear support relative to the rear platform about an upstanding steering axis and there is provided a pair of links extending diagonally between the front support and the rear support for communicating the steering movement of the front support to the rear support.

In another preferred arrangement which allows the same vehicle to operate on water, the front and rear supports are arranged to be removable from the front and rear platforms and there is provided a front float assembly for attachment to the front platform and a rear float assembly for attachment to the rear platform.

Preferably each float assembly includes an annular float member arranged horizontally under the respective platform.

In some cases each of the float assemblies includes a guide fin longitudinally of the respective float assembly for guiding movement over water longitudinally. This is particularly provided where the vehicle is intended for towing behind a powered craft.

In another arrangement there is provided a swivel bearing between the rear platform and the rear float assembly for steering movement of the rear float assembly relative to the rear platform about an upstanding steering axis and there is provided a pair of links extending diagonally between the front float assembly and the rear float assembly for communicating said steering movement of the front float assembly to the rear float assembly. This can be used in an arrangement for self-propelled operation where the front float assembly includes a pair of outwardly extending paddle members each arranged to paddle rearwardly on the water when moved rearwardly such that side to side steering movements of the front float assembly causes alternate paddling actions of the paddle members to propel the vehicle forwardly over the water.

### BRIEF DESCRIPTION OF THE DRAWINGS

One embodiment of the invention will now be described in conjunction with the accompanying drawings in which:

FIG. 1 is a top plan view of a vehicle according to the present invention arranged for travel over snow and/or ice as a sled.

FIG. 2 is a side elevational view of the vehicle of FIG. 1.

FIG. 3 is a top plan view of the axle and steering arrangement separated from the vehicle of FIG. 1 and showing the two axle automobile steering.

FIG. 3A is a front elevational view of the components of FIG. 3.

FIG. 3C is an exploded view of the components of FIG. 3.

FIG. 3D is front elevational view of the ski of FIG. 1.

FIG. 3E is side elevational view of the ski of FIG. 1.

FIG. 3F is a top plan view of the axle and steering arrangement similar to that of FIG. 3 and showing the two axle wagon steering.

FIG. 4 is a top plan view of the vehicle of FIG. 1 showing two axle wagon steering.

FIG. 5 is a side elevational view of the vehicle of FIG. 4.

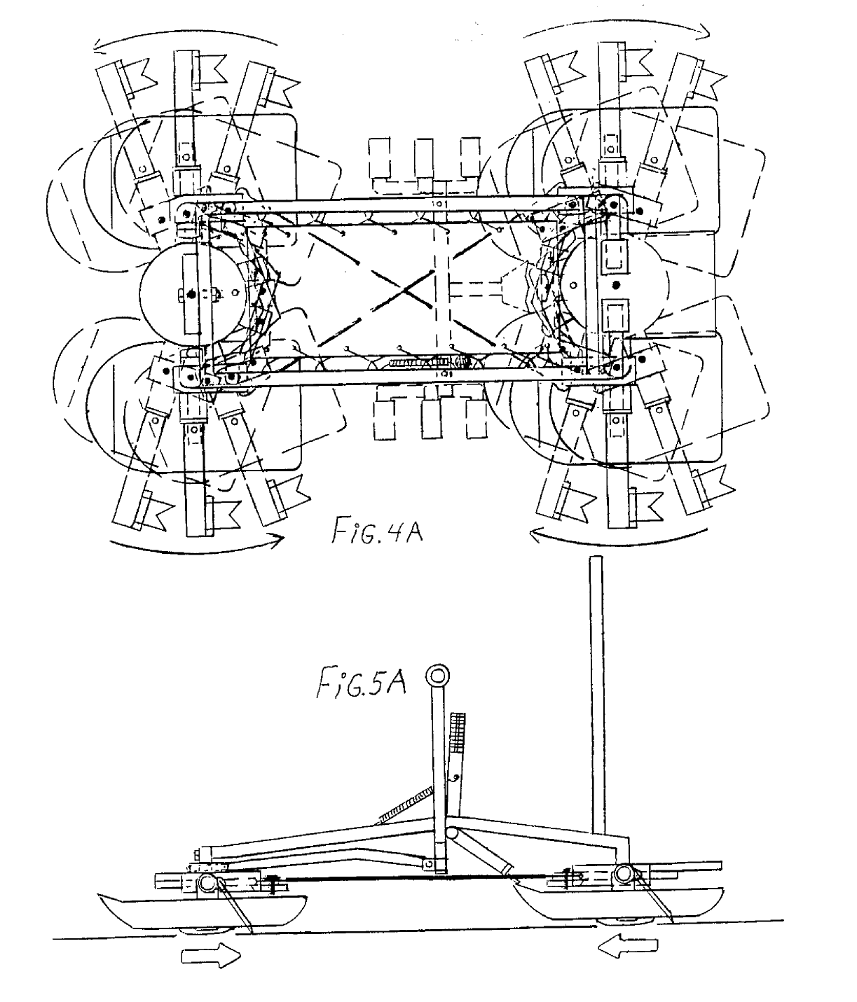

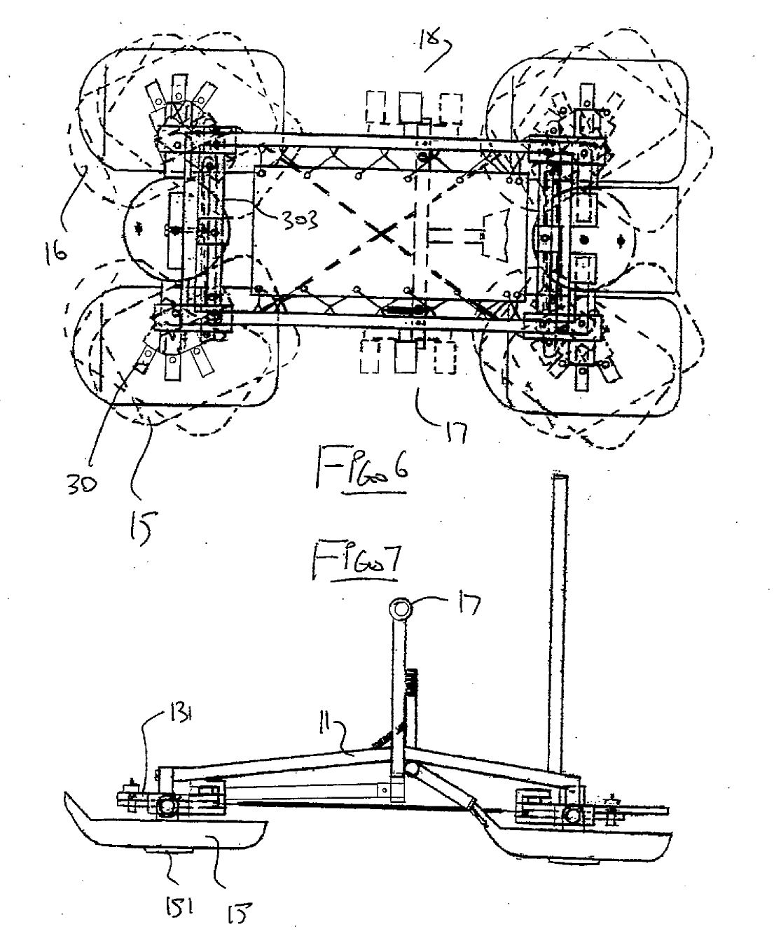

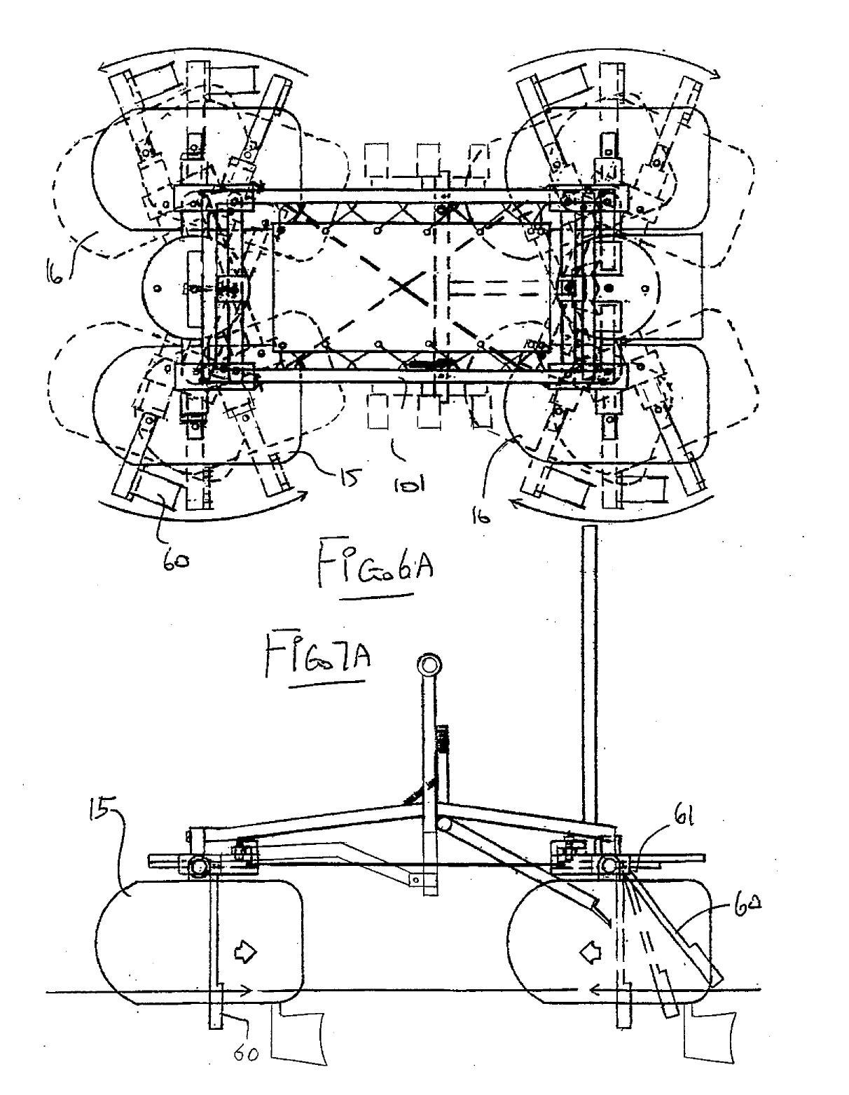

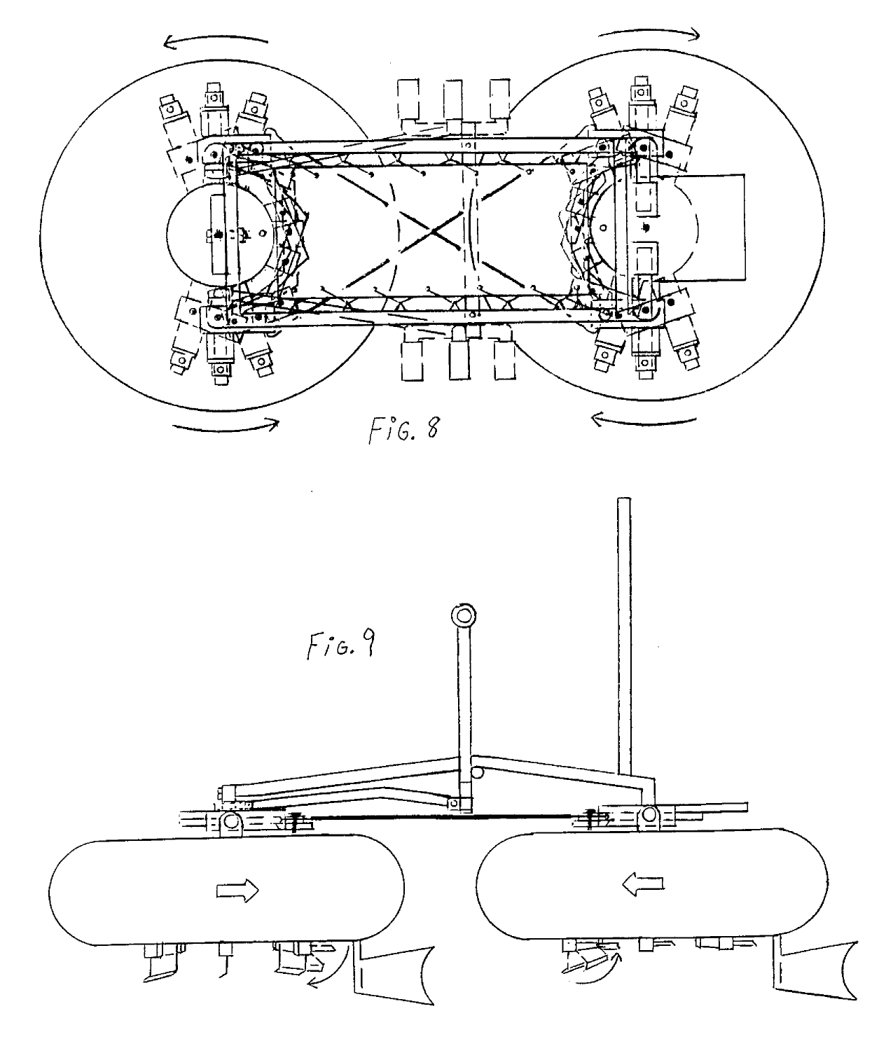

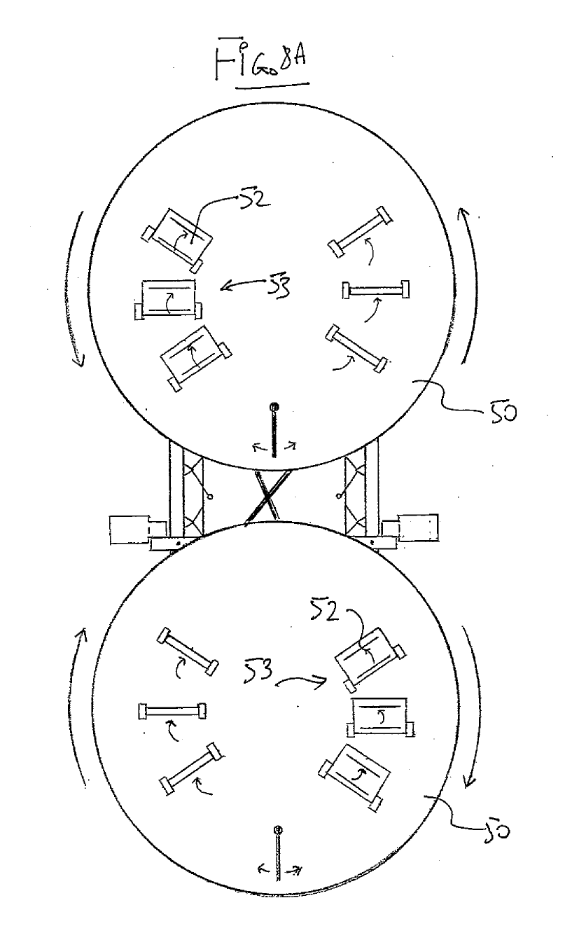

FIG. 4A is a top plan view of the vehicle of FIG. 4 showing the addition of a propulsion system.

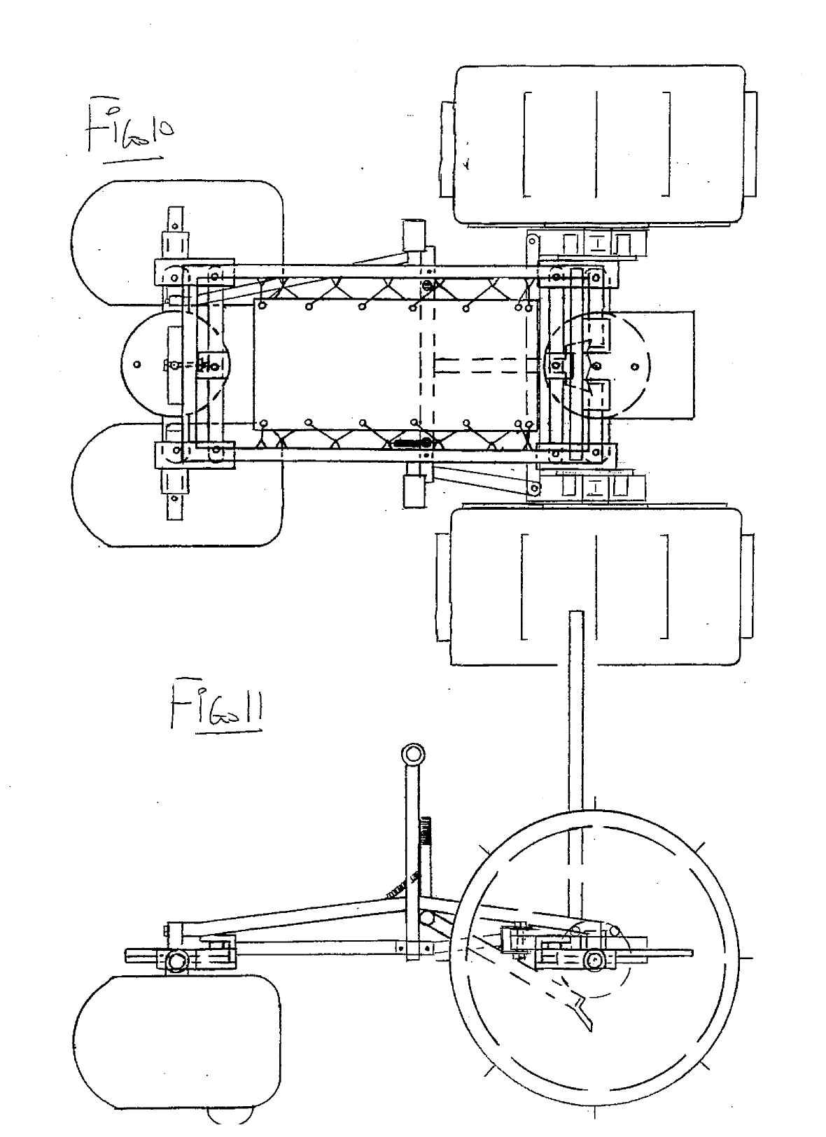

FIG. 5A is a side elevational view of the vehicle of FIG. 4A.

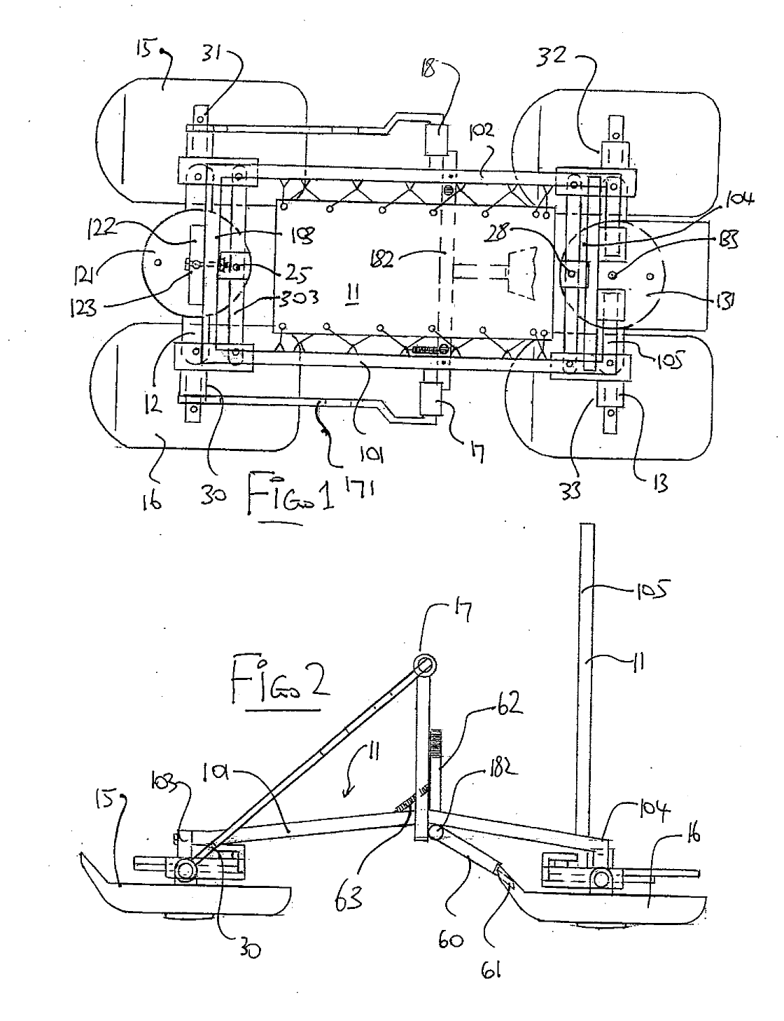

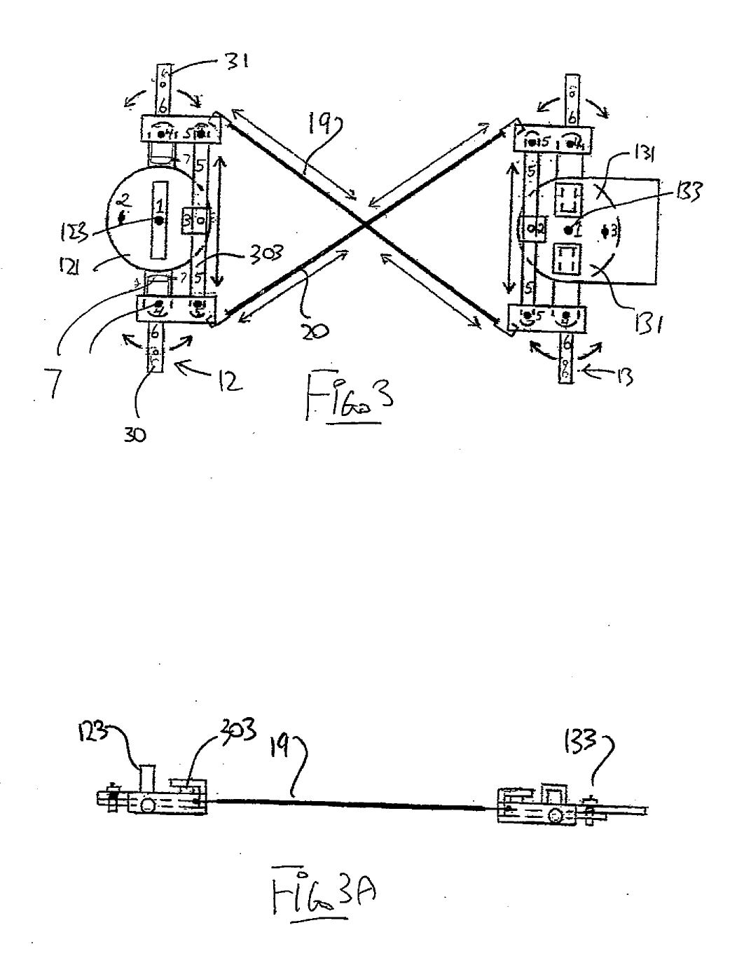

FIG. 6 is a top plan view of the vehicle of FIG. 1 showing two axle automobile steering.

FIG. 7 is a side elevational view of the vehicle of FIG. 6.

FIG. 6A is a top plan view of the vehicle of FIG. 6 showing the addition of a propulsion system.

FIG. 7A is a side elevational view of the vehicle of FIG. 6A.

FIG. 8 is a top plan view of the vehicle according to the present invention as shown in FIG. 1 showing the vehicle adapted for movement over water.

FIG. 8A is a bottom view of the vehicle of FIG. 8.

FIG. 9 is a side elevational view of the vehicle of FIG. 8.

FIG. 10 is a top plan view of the vehicle according to the present invention as shown in FIG. 1 showing the vehicle adapted with rear drive wheels.

FIG. 11 is a side elevational view of the vehicle of FIG. 10.

In the drawings like characters of reference indicate corresponding parts in the different figures.

### DETAILED DESCRIPTION

The apparatus for transporting a passenger shown in the figures includes a generally rectangular frame 10 defining two side rails 101, 102, a front cross member 103 and a rear cross member 104. The frame includes a rear back rest 105 against which the seated rider reclines.

A seat 11 formed for example of fabric sheets applied over the frame tubes is provided on the frame 10 for at least one passenger;

A generally horizontal front axle 12 is connected to the front cross member by a platform 121 fastened to the front rail 103 by a mounting 122 and fixed against side to side and front to rear tilting. The front axle includes a pivot coupling 123 for rotation of the axle relative to the platform 121 about a vertical steering axis.

Generally symmetrically there is provided a horizontal rear axle 13 which is connected to the rear cross member 104 by a platform 131 fastened to the rear rail 104 by mounting brackets 105 and fixed against side to side and front to rear tilting. The rear axle includes a pivot coupling 133 for rotation of the axle relative to the platform 131 about a vertical steering axis. The platforms provide a downwardly facing surface against which the axle slides as it rotates.

Two transversely spaced front support members in the form of skis 15, 16 are attached to the axles 12, 13 for movement therewith and for supporting the axles for movement across a support surface such as the ground, snow, ice or water.

The axles 12 and 13 provide steering movement of the skis 15, 16 operated by a pair of steering levers 17, 18 each on a respective side of the frame for operation by the passenger in forward and rearward movement of the steering lever. Each lever has a steering link 171, 181 extending from the lever to the front axle for causing steering movement of the front axle relative to the frame. The levers are mounted at respective sides of the frame and pivotal at the frame about an axis 182 parallel to the axles.

A first diagonally extending flexible connecting link or brace 19 extends from a right hand end 125 of the front axle to a left hand end 135 of the rear axle and a second diagonally extending flexible connecting link 20 extends from a left hand end 126 of the front axle to a right hand end 136 of the rear axle so that operation of the levers causes the front skis to turn in one direction while the rear skisturn in the opposite direction.

The front axle includes a first single coupling 123 allowing steering movement of the front axle 12 relative to the frame in a wagon steering mode as shown in FIG. 9 and includes two second couplings 127, 128 allowing individual steering movements of the support members relative to the front axle in a vehicle steering mode as shown in FIG. 8.

Symmetrically the rear axle includes a first single coupling 133 allowing steering movement of the rear axle relative to the frame in a wagon steering mode and includes two second couplings 137, 138 allowing individual steering movements of the support members relative to the rear axle in a vehicle steering mode.

Each of the skis of the front axle is mounted on a support link 30, 31 which is connected to the front axle 12 by one of the second couplings and the steering link 171 extends from the lever 17 to the support link 30 and symmetrically the steering link 181 extends from the lever 18 to the support link 31.

There is provided an arrangement for selecting either the first single coupling or the two second couplings to change the steering modes. This comprises inserting a locking pin 21, 22 at the support link 30 and removing a locking pin at the axle 12 and wherein the selection of the vehicle steering mode is obtained by removing a locking pin at the support link 30 and inserting a locking pin 25 at the axle. The rear axle operates symmetrically with pins 26, 27, 28.

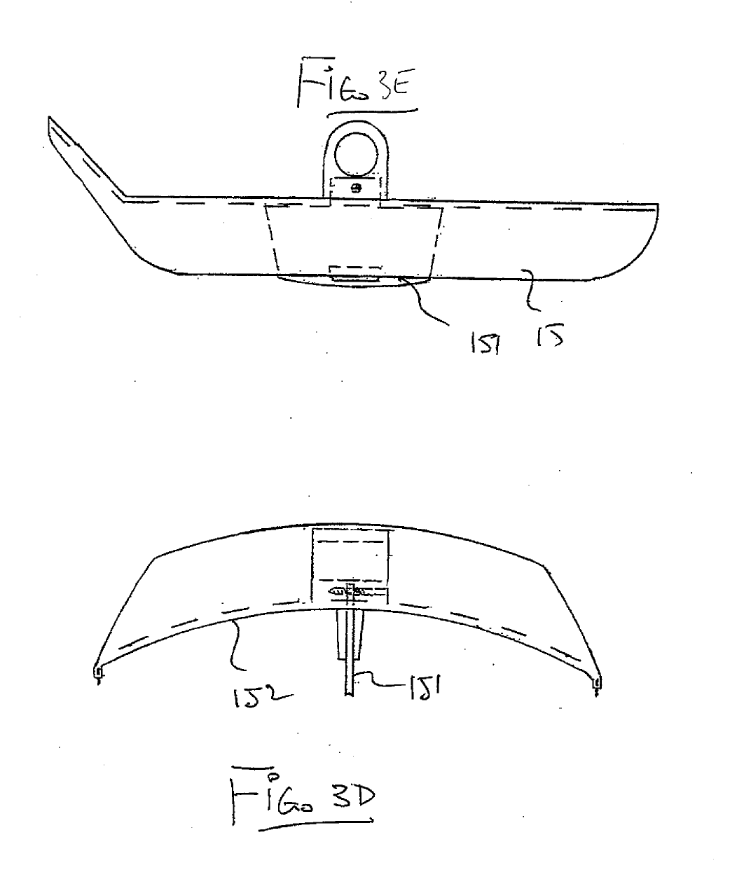

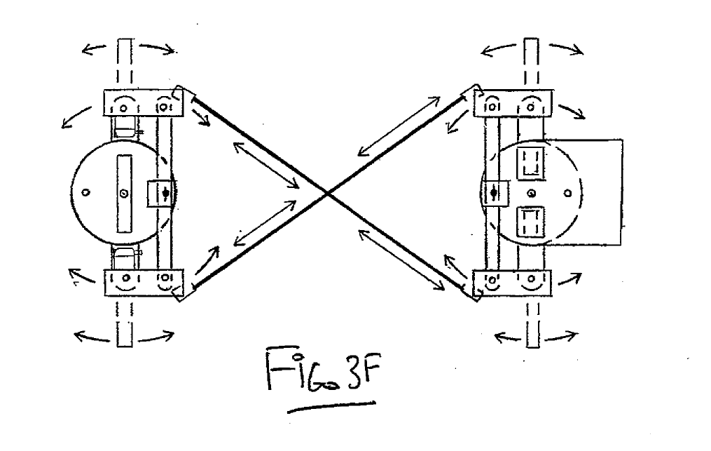

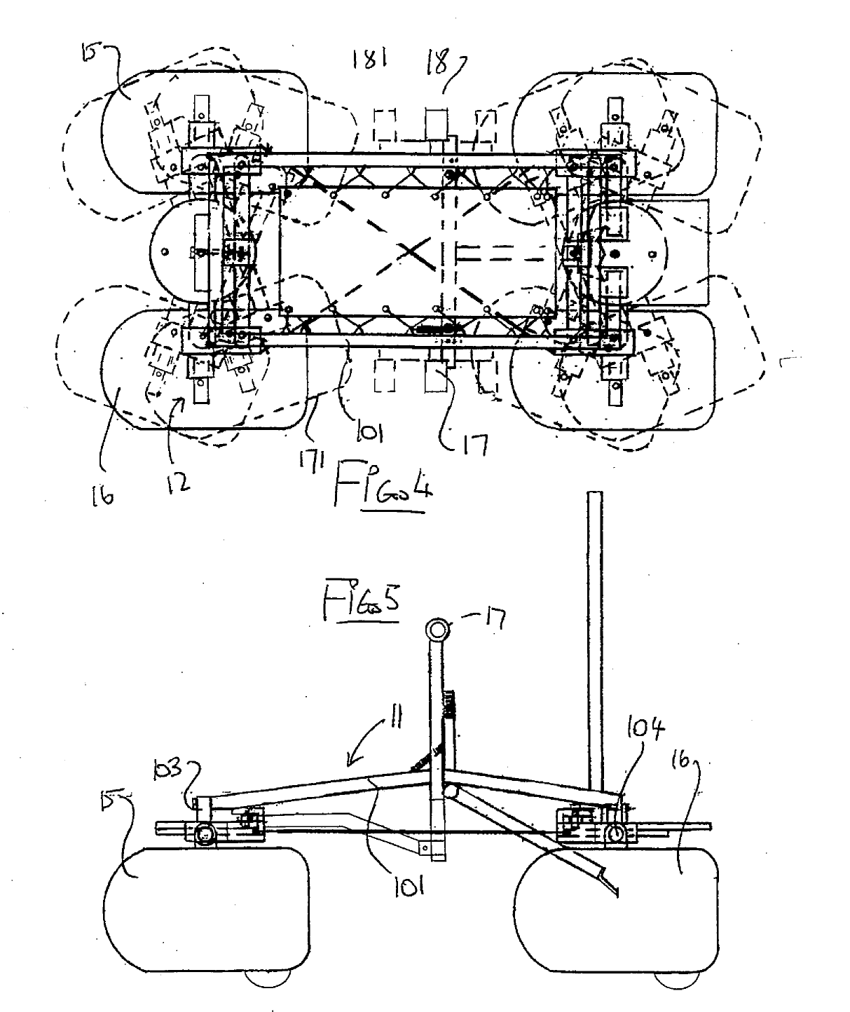

When skis are used as shown in FIGS. 3D and 3E, each of the skis includes a longitudinally extending blade 151, 16 therein extending along a central line of a concave under surface 152 of the ski.

The skis are replaceable so that a selection can be made between wheels and a float assembly (FIGS. 8, 9). In FIG. 8, each float assembly comprises a tube 50 arranged horizontally under the respective axle with a guide fin 51 longitudinally of the respective float assembly for guiding movement over water longitudinally. Each of the float assemblies 50 includes outwardly extending paddle members 52 each arranged to paddle rearwardly on the surface when moved rearwardly such that rotational steering movements of the floats 50 cause alternate paddling actions of the paddle members to propel the frame forwardly over the surface. That is the paddle members 52 are arranged to paddle against the surface in the rearward direction and to side over the surface a forward direction as shown at 53.

As shown in FIG. 3C, the link 30 is generally L-shaped with a leg 301 to which the ski is attached and a leg 302 to which the steering link 171 is attached. In addition a connecting link 303 extends across between the link 30 and the link 31 on the opposite side for maintaining a common steering angle between the skis.

Referring now to FIGS. 3, 3A, 3B and 3C, the operation of the device is as follows:

Attach plate mechanism by number.

I-2 main plates II-1 Front plate

III-1 Rear Plate IV-4 steering arms

V-2 Control Steering rods

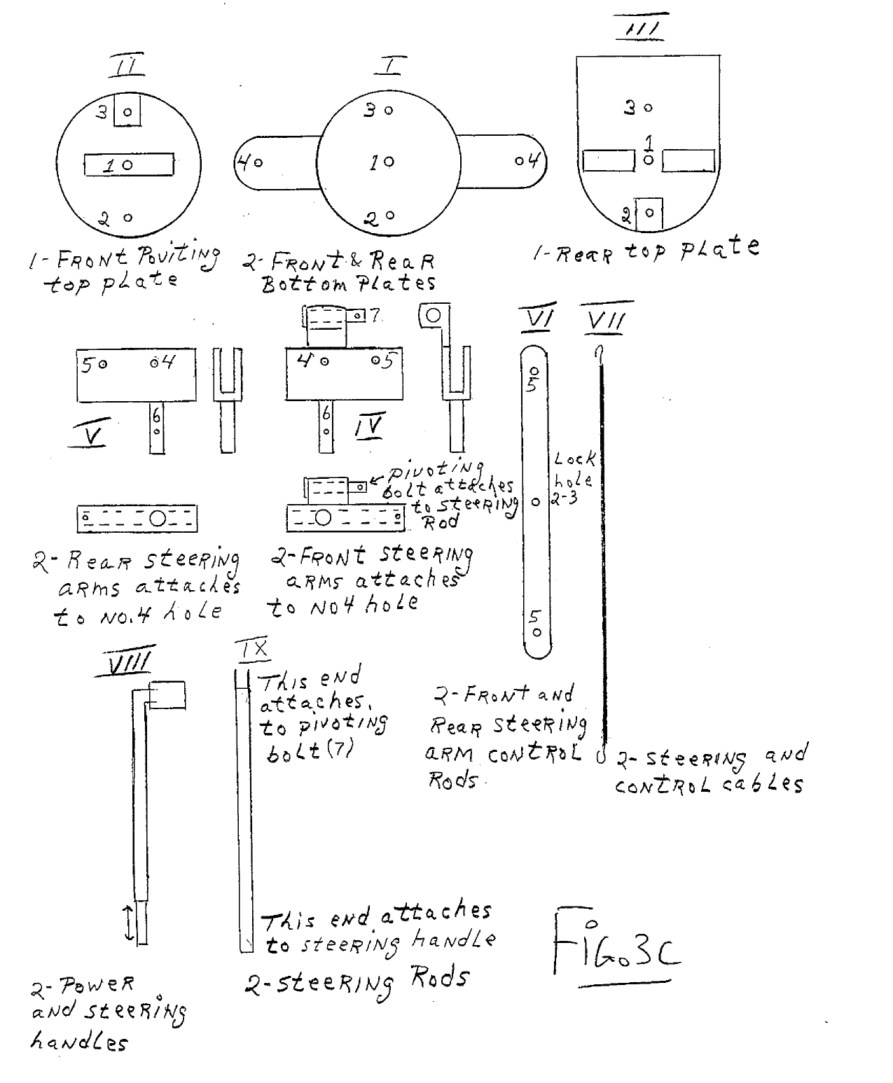

These two plates (front and rear) attach to a snap on sled frame as shown on FIGS. 2 and 4. Once the plates are attached to the sled frame the front plate will pivot sideways to give the sled a smooth ride and the rear plate is rigid, this will stabilize the sled. The skis, pontoon type skis and the tube attach to piece number IV-6. These attachments will enable the devices to move up and down to further give the sled a smoother ride.

By simply moving one bolt (2 or 3) in each plate you have two types of steering.

Two axle automobile type steering see FIGS. 1 and 2

Two axle wagon type steering is shown in FIGS. 4 and 5. One can add on propulsion adaptor adaptors systems to this steering design as shown in FIG. 4A and 5A whereupon the propulsion system is activated by just pumping the steering handles.

To get only front steering just remove the two cables. To stabilize the rear plate holes 1, 2 and 3 must have bolt in them.

A brake 60 is provided and comprises a blade 61 for engaging the ground or snow cover in the centre between the skis and a handle 62 operable by the seated passenger at one side or both sides of the frame and pulled into a retracted position by a spring 63. The length of the arm carrying the blade is extendible to allow the operator to select a required length in respect of the surface over which the vehicle is travelling.

The rear platform 131 includes a rear panel 13R extending behind the rear axle between the rear skis for a second passenger to stand on.

Due to the sled's unique steering and propulsion mechanism system, when the rider moves the handle the other handle moves simultaneously in the other direction setting off a chain of events that makes the sled turn in a circular motion.

The front control board 121 is connected to the front axle 12. They pivot each other because they are connected to the bolt and nut 123. The pivoting axle 12 is connected to the pivoting arm which is connected to the frame 10. The pivoting arm enables the platform 121 to pivot two different ways sideways and up and down. The rear platform 131 is connected to the rear pivoting board and pivots relative to each other by means of the (A) bolt and nut.

The rear platform pivots up and down unless otherwise locked when connected to the frame 10. The steering handles 17, 18 are connected to the frame and connection pipe which is connected to the steering arm 171 which is connected to the unit control pipe 303 and the criss-cross control cables 19, 20.

All five sled snap-on adapters function on the same operating principles to steer and propel the sled. To propel the sled forward, one must pump the handles by pushing them forward and backward. This handle pumping action will enable paddles 60 shown in FIGS. 4A and 6A to push the sled forward, while simultaneously moving the other paddles in the forward motion and they in turn will move the sled forward. The paddles hinge at the top 61 so that when pushed rearwardly by the steering handles they are fixed with the steering and the rear movement pushes the vehicle forwards. On the return stroke the paddles pivot rearwardly and therefore feather relative to the surface on which the vehicle is carried so as to provide no rear propulsion. The paddles 60 are blades when used in water or snow and can be spiked when used on ground or ice.

Since various modifications can be made in my invention as herein above described, and many apparently widely different embodiments of same made within the spirit and scope of the claims without department from the scope, it is intended that all matter contained in the accompanying specification shall be interpreted as illustrative only and not in a limiting sense.

1. Apparatus for transporting a passenger comprising:
a generally rectangular frame defining two side rails a front cross member and a rear cross member;
a seat on the frame for at least one passenger;
a generally horizontal front axle connected to the front cross member;
a generally horizontal rear axle connected to the rear cross member;
two transversely spaced front support members attached to the front axle for movement therewith and for supporting the front axle for movement across the a support surface;
two transversely spaced rear support members attached to the front paxle for movement therewith and for supporting the front axle for movement across the support surface;
a swivel coupling for steering movement of the front support members relative to the frame about an upstanding steering axis;
a swivel coupling between the rear axle and frame for steering movement of the rear support members relative to the frame about an upstanding steering axis;
a pair of steering levers each on a respective side of the frame for operation by the passenger in forward and rearward movement of the steering lever, each lever having a steering link extending from the lever to the front axle for causing steering movement of the front axle relative to the frame;
and a first diagonally extending flexible connecting link extending from a right hand end of the front axle to a left hand end of the rear axle and a second diagonally extending flexible connecting link extending from a left hand end of the front axle to a right hand end of the rear axle so that operation of the levers causes the front support members to turn in one direction while the rear support members turn in the opposite direction.

2. The apparatus according to claim 1 wherein the front axle includes a first single coupling allowing steering movement of the front axle relative to the frame in a wagon steering mode and includes two second couplings allowing individual steering movements of the support members relative to the front axle in a vehicle steering mode, wherein the rear axle includes a first single coupling allowing steering movement of the rear axle relative to the frame in a wagon steering mode and includes two second couplings allowing individual steering movements of the support members relative to the rear axle in a vehicle steering mode, and wherein there is provided an arrangement for selecting either the first single coupling or the two second couplings to change the steering modes.

3. The apparatus according to claim 2 wherein each of the support members of the front axle is mounted on a support link which is connected to the front axle by one of the second couplings and wherein the steering link extends from the lever to the support link.

4. The apparatus according to claim 3 wherein the selection of the wagon steering mode is obtained by inserting a locking pin at the support link and removing a locking pin at the axle and wherein the selection of the vehicle steering mode is obtained by removing a locking pin at the support link and inserting a locking pin at the axle.

5. The apparatus according to claim 1 wherein the levers are mounted at respective sides of the frame and pivotal at the frame about an axis parallel to the axles.

6. The apparatus according to claim 1 wherein the support members comprise skis.

7. The apparatus according to claim 6 wherein each of the skis includes a longitudinally extending blade therein.

8. The apparatus according to claim 1 wherein the support members are replaceable so that a selection can be made between wheels, skis and a float assembly.

9. The apparatus according to claim 8 wherein each float assembly includes an annular float member arranged horizontally under the respective axle.

10. The apparatus according to claim 8 wherein each of the float assemblies includes a guide fin longitudinally of the respective float assembly for guiding movement over water longitudinally.

11. The apparatus according to claim 12 wherein each of the support members includes a pair of outwardly extending paddle members each arranged to paddle rearwardly on the surface when moved rearwardly such that side to side steering movements of the support members cause alternate paddling actions of the paddle members to propel the frame forwardly over the surface.

12. The apparatus according to claim 11 wherein the paddle members are arranged to paddle against the surface in the rearward direction and to side over the surface a forward direction.

13. The apparatus according to claim 1 wherein the frame includes a front platform providing a downwardly facing surface against which the front axle slides and a rear platform providing a downwardly facing surface against which the rear axle slides.

14. The apparatus according to claim 1 wherein the seat assembly is formed by fabric panels.
